(19) United States
(12) Patent Application Publication
(10) Pub. No.: US 2012/0008686 A1
(43) Pub. Date: Jan. 12, 2012

(54) MOTION COMPENSATION USING VECTOR QUANTIZED INTERPOLATION FILTERS

(75) Inventor: Barin Geoffry Haskell, Mountain View, CA (US)

(73) Assignee: APPLE INC., Cupertino, CA (US)

(21) Appl. No.: 12/875,029

(22) Filed: Sep. 2, 2010

Related U.S. Application Data
(60) Provisional application No. 61/361,768, filed on Jul. 6, 2010.

(51) Int. Cl. H04N 7/32

(52) U.S. Cl. 375/240.16; 375/E07.123

(57) ABSTRACT

The present disclosure describes use of dynamically assignable interpolation filters as part of motion compensated prediction. An encoder and a decoder each may store common codebooks that define a variety of interpolation filters that may be applied to predicted video data. During runtime coding, an encoder calculates characteristics of an ideal interpolation filter to be applied to a reference block that would minimize prediction error when the reference block would be used to predict an input block of video data. Once the characteristics of the ideal filter are identified, the encoder may search its local codebook to find a filter that best matches the idea filter. The encoder may filter the reference block by the best matching filter stored in the codebook as it codes the input block. The encoder also may transmit an identifier of the best matching filter to a decoder, which will use the interpolation filter on predicted block as it decodes coded data for the block.

### CROSS-REFERENCE TO RELATED APPLICATIONS

The present application claims the benefit of U.S. Provisional application, Ser. No. 61/361,768 filed Jul. 6, 2010, entitled “MOTION COMPENSATION USING VECTOR QUANTIZED INTERPOLATION FILTERS.” The aforementioned application is incorporated herein by reference in its entirety.

### BACKGROUND

The present invention relates to video coding and, more particularly, to video coding system using interpolation filters as part of motion-compensated coding.

Video codecs typically code video frames using a discrete cosine transform (“DCT”) on blocks of pixels, called “pixel blocks” herein, much the same as used for the original JPEG coder for still images. An initial frame (called an “intra” frame) is coded and transmitted as an independent frame. Subsequent frames, which are modeled as changing slowly due to small motions of objects in the scene, are coded efficiently in the inter mode using a technique called motion compensation (“MC”) in which the displacement of pixel blocks from their position in previously-coded frames are transmitted as motion vectors together with a coded representation of a difference between a predicted pixel block and a pixel block from the source image.

A brief review of motion compensation is provided below. FIGS. 1 and 2 show block diagrams of a motion-compensated image coder/decoder system. The system combines transform coding (in the form of the DCT of pixel blocks of pixels) with predictive coding (in the form of differential pulse coded modulation (“PCM”)) in order to reduce storage and computation of the compressed image, and at the same time to give a high degree of compression and adaptability. Since motion compensation is difficult to perform in the transform domain, the first step in the interframe coder is to create a motion compensated prediction error. This computation requires one or more frame stores in both the encoder and decoder. The resulting error signal is transformed using a DCT, quantized by an adaptive quantizer, entropy encoded using a variable length coder (“VLC”) and buffered for transmission over a channel.

The way that the motion estimator works is illustrated in FIG. 3. In its simplest form the current frame is partitioned into motion compensation blocks, called “mcblocks” herein, of constant size, e.g., 16×16 or 8×8. However, variable size mcblocks are often used, especially in newer codecs such as H.264. ITU-T Recommendation H.264, Advanced Video Coding. Indeed nonrectangular mcblocks have also been studied and proposed. Mcblocks are generally larger than or equal to pixel blocks in size.

Again, in the simplest form of motion compensation, the previous decoded frame is used as the reference frame, as shown in FIG. 3. However, one of many possible reference frames may also be used, especially in newer codecs such as H.264. In fact, with appropriate signaling, a different reference frame may be used for each mcblock.

Each mcblock in the current frame is compared with a set of displaced mcblocks in the reference frame to determine which one best predicts the current mcblock. When the best matching mcblock is found, a motion vector is determined that specifies the displacement of the reference mcblock.

Exploiting Spatial Redundancy

Because video is a sequence of still images, it is possible to achieve some compression using techniques similar to JPEG. Such methods of compression are called intraframe coding techniques, where each frame of video is individually and independently compressed or encoded. Intraframe coding exploits the spatial redundancy that exists between adjacent pixels of a frame. Frames coded using only intraframe coding are called “I-frames”.

Exploiting Temporal Redundancy

In the unidirectional motion estimation described above, called “forward prediction”, a target mcblock in the frame to be encoded is matched with a set of mcblocks of the same size in a past frame called the “reference frame”. The mcblock in the reference frame that “best matches” the target mcblock is used as the reference mcblock. The prediction error is then computed as the difference between the target mcblock and the reference mcblock. Prediction mcblocks do not, in general, align with coded mcblock boundaries in the reference frame. The position of this best-matching reference mcblock is indicated by a motion vector that describes the displacement between it and the target mcblock. The motion vector information is also encoded and transmitted along with the prediction error. Frames coded using forward prediction are called “P-frames”.

The prediction error itself is transmitted using the DCT-based intraframe encoding technique summarized above.

Bidirectional Temporal Prediction

Bidirectional temporal prediction, also called “Motion-Compensated Interpolation”, is a key feature of modern video codecs. Frames coded with bidirectional prediction use two reference frames, typically one in the past and one in the future. However, two of many possible reference frames may also be used, especially in newer codecs such as H.264. In fact, with appropriate signaling, different reference frames may be used for each mcblock.

A target mcblock in bidirectionally-coded frames can be predicted by a mcblock from the past reference frame (forward prediction), or one from the future reference frame (backward prediction), or by an average of two mcblocks, one from each reference frame (interpolation). In every case, a prediction mcblock from a reference frame is associated with a motion vector, so that up to two motion vectors per mcblock may be used with bidirectional prediction. Motion-Compensated Interpolation for a mcblock in a bidirectionally-predicted frame is illustrated in FIG. 4. Frames coded using bidirectional prediction are called “B-frames”.

Bidirectional prediction provides a number of advantages. The primary one is that the compression obtained is typically higher than can be obtained from forward (unidirectional) prediction alone. To obtain the same picture quality, bidirectionally-predicted frames can be encoded with fewer bits than frames using only forward prediction.

However, bidirectional prediction does introduce extra delay in the encoding process, because frames must be encoded out of sequence. Further, it entails extra encoding complexity because mcblock matching (the most computationally intensive encoding procedure) has to be performed twice for each target mcblock, once with the past reference frame and once with the future reference frame.

Typical Encoder Architecture for Bidirectional Prediction

FIG. 5 shows a typical bidirectional video encoder. It is assumed that frame reordering takes place before coding, i.e., I- or P-frames used for B-frame prediction must be coded and transmitted before any of the corresponding B-frames. In this codec, B-frames are not used as reference frames. With a change of architecture, they could be as in H.264.

Input video is fed to a Motion Compensation Estimator/Predictor that feeds a prediction to the minus input of the subtractor. For each mcblock, the Inter/Intra Classifier then compares the input pixels with the prediction error output of the subtractor. Typically, if the mean square prediction error exceeds the mean square pixel value, an intra mcblock is decided. More complicated comparisons involving DCT of both the pixels and the prediction error yield somewhat better performance, but are not usually deemed worth the cost.

For intra mcblocks the prediction is set to zero. Otherwise, it comes from the Predictor, as described above. The prediction error is then passed through the DCT and quantizer before being coded, multiplexed and sent to the Buffer.

Quantized levels are converted to reconstructed DCT coefficients by the Inverse Quantizer and then the inverse is transformed by the inverse DCT unit (“IDCT”) to produce a coded prediction error. The Adder adds the prediction to the prediction error and clips the result, e.g., to the range 0 to 255, to produce coded pixel values.

For B-frames, the Motion Compensation Estimator/Predictor uses both the previous frame and the future frame kept in picture stores.

For I- and P-frames, the coded pixels output by the Adder are written to the Next Picture Store, while at the same time the old pixels are copied from the Next Picture store to the Previous Picture store. In practice, this is usually accomplished by a simple change of memory addresses.

Also, in practice the coded pixels may be filtered by an adaptive deblocking filter prior to entering the picture stores. This improves the motion compensation prediction, especially for low bit rates where coding artifacts may become visible.

The Coding Statistics Processor in conjunction with the Quantizer Adapter controls the output bit-rate and optimizes the picture quality as much as possible.

Typical Decoder Architecture for Bidirectional Prediction

FIG. 6 shows a typical bidirectional video decoder. It has a structure corresponding to the pixel reconstruction portion of the encoder using inverting processes. It is assumed that frame reordering takes place after decoding and video output. The interpolation filter might be placed at the output of the motion compensated predictor as in the encoder.

Fractional Motion Vector Displacements

FIG. 3 and FIG. 4 show reference mcblocks in reference frames as being displaced vertically and horizontally with respect to the position of the current mcblock being decoded in the current frame. The amount of the displacement is represented by a two-dimensional vector [dx, dy], called the motion vector. Motion vectors may be coded and transmitted, or they may be estimated from information already in the decoder, in which case they are not transmitted. For bidirectional prediction, each transmitted mcblock requires two motion vectors.

In its simplest form, dx and dy are signed integers representing the number of pixels horizontally and the number of lines vertically to displace the reference mcblock. In this case, reference mcblocks are obtained merely by reading the appropriate pixels from the reference stores.

However, in newer video codecs it has been found beneficial to allow fractional values for dx and dy. Typically, they allow displacement accuracy down to a quarter pixel, i.e., an integer+−0.25, 0.5 or 0.75.

Fractional motion vectors require more than simply reading pixels from reference stores. In order to obtain reference mcblock values for locations between the reference store pixels, it is necessary to interpolate between them.

Simple bilinear interpolation can work fairly well. However, in practice it has been found beneficial to use two-dimensional interpolation filters especially designed for this purpose. In fact, for reasons of performance and practicality, the filters are often not shift-invariant filters. Instead different values of fractional motion vectors may utilize different interpolation filters.

Motion Compensation Using Adaptive Interpolation Filters

The optimum motion compensation interpolation filter depends on a number of factors. For example, objects in a scene may not be moving in pure translation. There may be object rotation, both in two dimensions and three dimensions. Other factors include zooming, camera motion and lighting variations caused by shadows, or varying illumination.

Camera characteristics may vary due to special properties of their sensors. For example, many consumer cameras are intrinsically interlaced, and their output may be de-interlaced and filtered to provide pleasing-looking pictures free of interlacing artifacts. Low light conditions may cause an increased exposure time per frame, leading to motion dependent blur of moving objects. Pixels may be non-square.

Thus, in many cases improved performance can be had if the motion compensation interpolation filter can adapt to these and other outside factors. In such systems interpolation filters may be designed by minimizing the mean square error between the current mcblocks and their corresponding reference mcblocks over each frame. These are the so-called Wiener filters. The filter coefficients would then be quantized and transmitted at the beginning of each frame to be used in the actual motion compensated coding.

### BRIEF DESCRIPTION OF THE DRAWINGS

FIG. 1 is a block diagram of a conventional video coder.

FIG. 2 is a block diagram of a conventional video decoder.

FIG. 3 illustrates principles of motion compensated prediction.

FIG. 4 illustrates principles of bidirectional temporal prediction.

FIG. 5 is a block diagram of a conventional bidirectional video coder.

FIG. 6 is a block diagram of a conventional bidirectional video decoder.

FIG. 7 illustrates an encoder/decoder system suitable for use with embodiments of the present invention.

FIG. 8 is a simplified block diagram of a video encoder according to an embodiment of the present invention.

FIG. 9 illustrates a method according to an embodiment of the present invention.

FIG. 10 illustrates a method according to another embodiment of the present invention.

FIG. 11 is a simplified block diagram of a video decoder according to an embodiment of the present invention.

FIG. 12 illustrates a method according to a further embodiment of the present invention.

FIG. 13 illustrates a codebook architecture according to an embodiment of the present invention.

FIG. 14 illustrates a codebook architecture according to another embodiment of the present invention.

FIG. 15 illustrates a codebook architecture according to a further embodiment of the present invention.

FIG. 16 illustrates a decoding method according to an embodiment of the present invention.

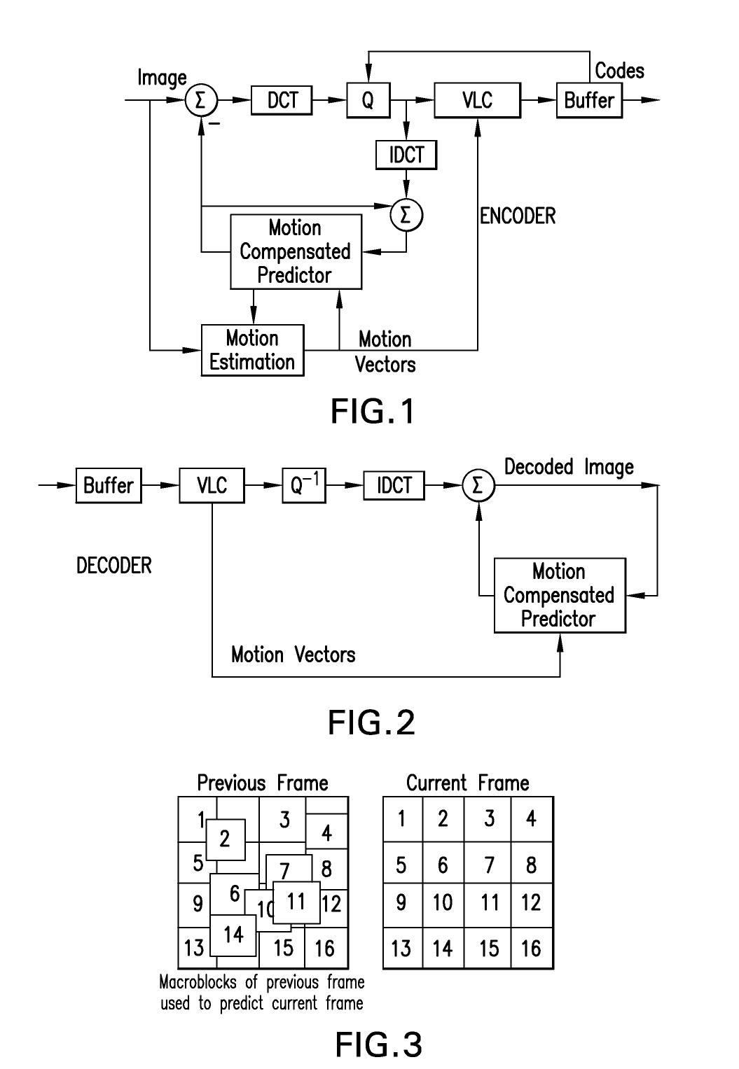

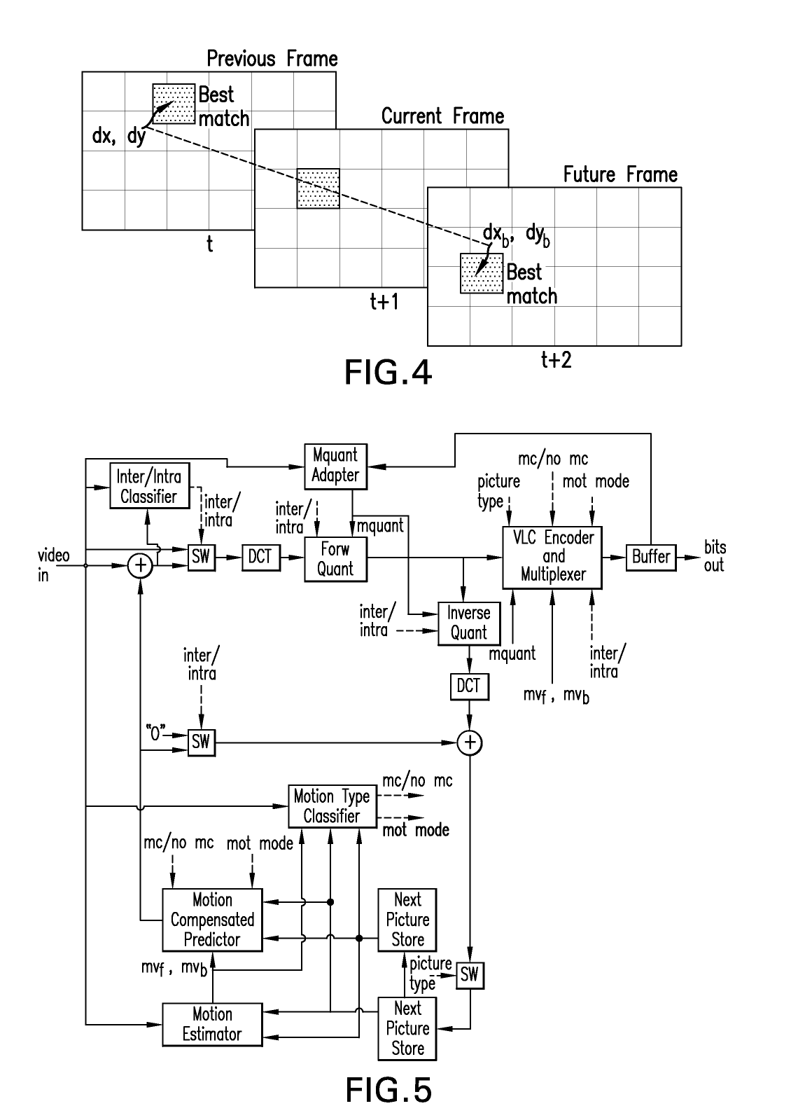

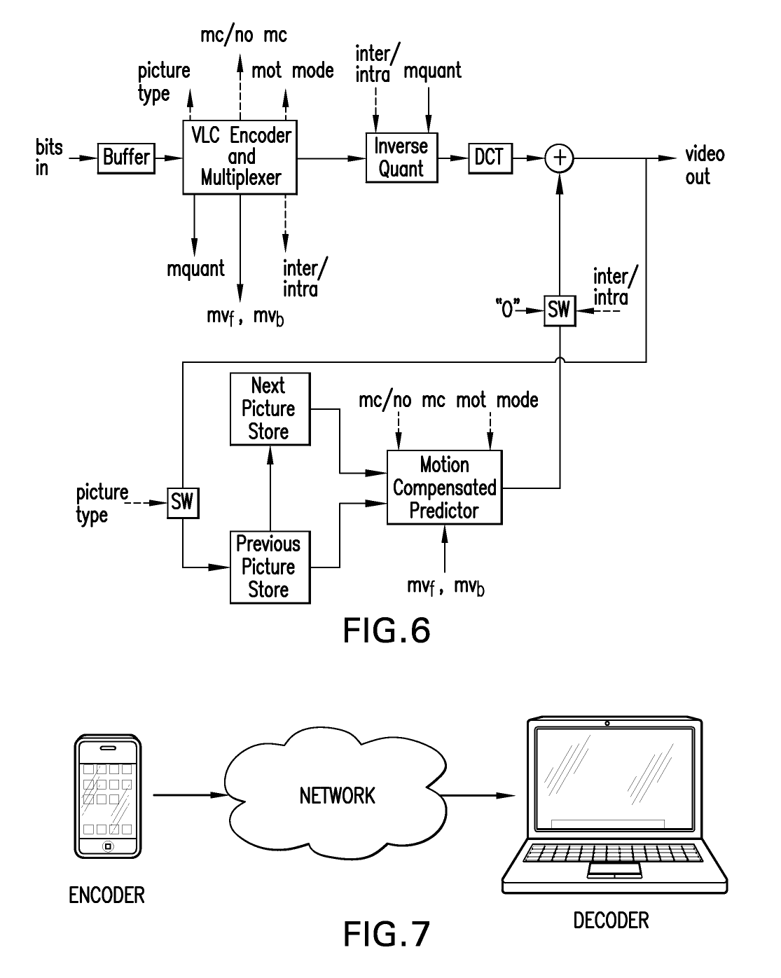

### DETAILED DESCRIPTION

Embodiments of the present invention provide a video coder/decoder system that uses dynamically assignable interpolation filters as part of motion compensated prediction. An encoder and a decoder each may store common codebooks that define a variety of interpolation filters that may be applied to predicted video data. During runtime coding, an encoder calculates characteristics of an ideal interpolation filter to be applied to a reference block that would minimize prediction error when the reference block would be used to predict an input block of video data. Once the characteristics of the ideal filter are identified, the encoder may search its local codebook to find a filter that best matches the ideal filter. The encoder may filter the reference block by the best matching filter stored in the codebook as it codes the input block. The encoder also may transmit an identifier of the best matching filter to a decoder, which will use the interpolation filter on a predicted block as it decodes coded data for the block.

Motion Compensation Using Vector Quantized Interpolation Filters—VQIF

Improved codec performance can be achieved if an interpolation filter can be adapted to each mcblock. However, transmitting a filter per mcblock is usually too expensive. Accordingly, embodiments of the present invention propose to use a codebook of filters and send an index into the codebook for each mcblock.

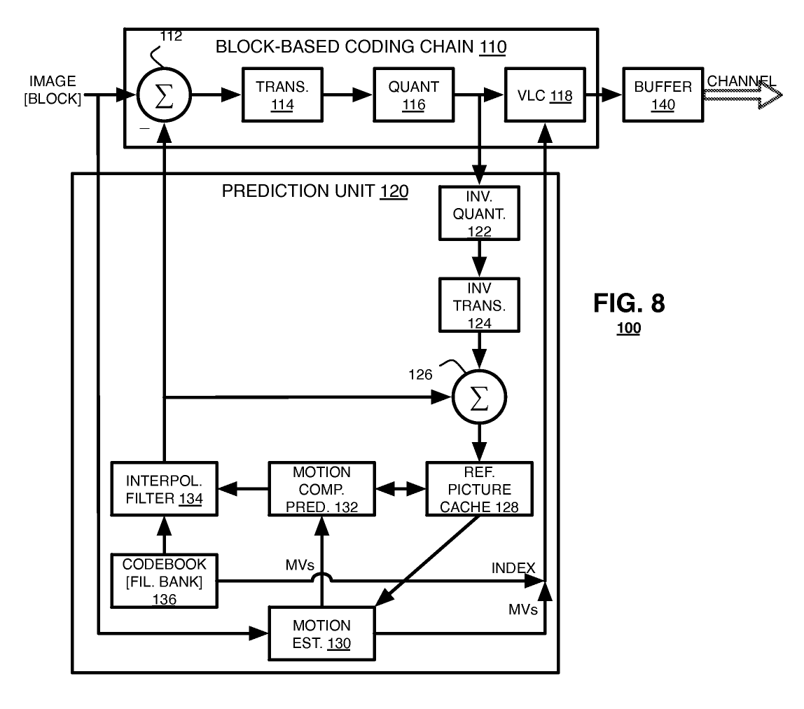

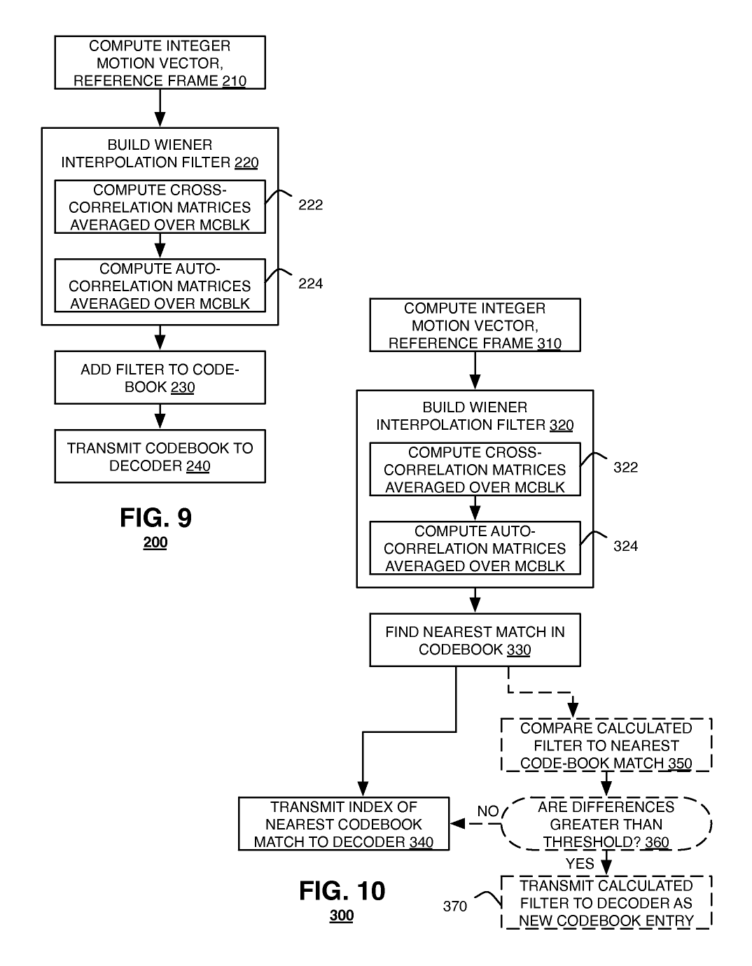

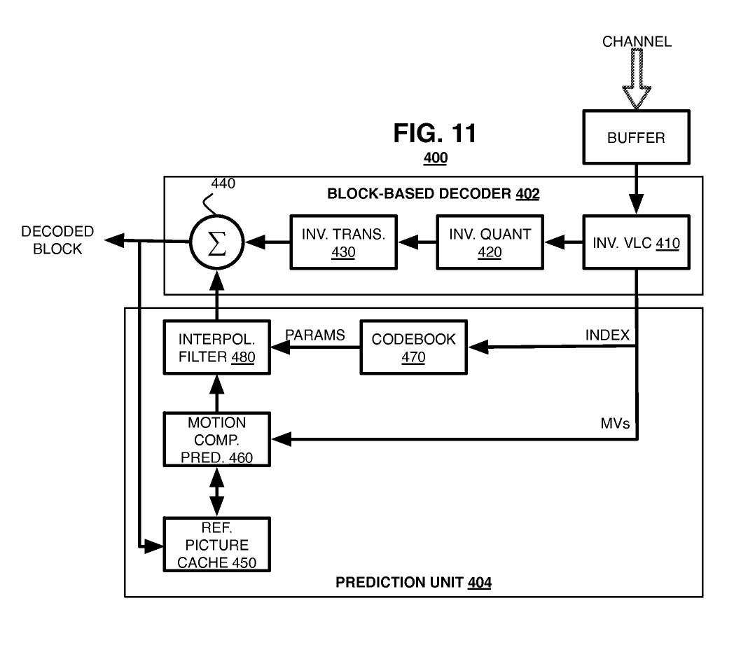

Embodiments of the present invention provide a method of building and applying filter codebooks between an encoder and a decoder (FIG. 7). FIG. 8 illustrates a simplified block diagram of an encoder system showing operation of the interpolation filter. FIG. 9 illustrates a method of building a codebook according to an embodiment of the present invention. FIG. 10 illustrates a method of using a codebook during runtime coding and decoding according to an embodiment of the present invention. FIG. 11 illustrates a simplified block diagram of a decoder showing operation of the interpolation filter and consumption of the codebook indices.

FIG. 8 is a simplified block diagram of an encoder suitable for use with the present invention. The encoder 100 may include a block-based coding chain 110 and a prediction unit 120.

The block coding chain 110 may include a subtractor 112, a transform unit 114, a quantizer 116 and a variable length coder 118. The subtractor 112 may receive an input mcblock from a source image and a predicted mcblock from the prediction unit 120. It may subtract the predicted mcblock from the input mcblock, generating a block of pixel residuals. The transform unit 114 may convert the mcblock's residual data to an array of transform coefficient according to a spatial transform, typically a discrete cosine transform (“DCT”) or a wavelet transform. The quantizer 116 may truncate transform coefficients of each block according to a quantization parameter (“QP”). The QP values used for truncation may be transmitted to a decoder in a channel. The variable length coder 118 may code the quantized coefficients according to an entropy coding algorithm, for example, a variable length coding algorithm. Following variable length coding, the coded data of each mcblock may be stored in a buffer 140 to await transmission to a decoder via a channel.

The prediction unit 120 may include: an inverse quantization unit 122, an inverse transform unit 124, an adder 126, a reference picture cache 128, a motion estimator 130, a motion compensated predictor 132, an interpolation filter 134 and a codebook 136. The inverse quantization unit 122 may quantize coded video data according to the QP used by the quantizer 116. The inverse transform unit 124 may transform re-quantized coefficients to the pixel domain. The adder 126 may add pixel residuals output from the inverse transform unit 124 with predicted motion data from the motion compensated predictor 132. The reference picture cache 128 may store recovered frames for use as reference frames during coding of later-received mcblocks. The motion estimator 130 may estimate image motion between a source image being coded and reference frame(s) stored in the reference picture cache. For example, it may select a prediction mode to be used (for example, unidirectional P-coding or bidirectional B-coding), and generate motion vectors for use in such predictive coding. The motion compensated predictor 132 may generate a predicted mcblock for use by the block coder. In this regard, the motion compensated predictor may retrieve stored mcblock data of the selected reference frames. The interpolation filter 134 may filter a predicted mcblock from the motion compensated predictor 132 according to configuration parameters output by codebook 136. The codebook 136 may store configuration data that defines operation of the interpolation filter 134. Different instances of configuration data are identified by an index into the codebook.

During coding operations, motion vectors, quantization parameters and codebook indices may be output to a channel along with coded mcblock data for decoding by a decoder (not shown).

FIG. 9 illustrates a method according to an embodiment of the present invention. According to the embodiment, a codebook may be constructed by using a large set of training sequences having a variety of detail and motion characteristics. For each mcblock, an integer motion vector and reference frame may be computed according to traditional techniques (box 210). Then, an N×Wiener interpolation filter may be constructed (box 220) by computing cross-correlation matrices (box 222) and auto-correlation matrices (box 224) between uncoded pixels and coded pixels from the reference picture cache, each averaged over the mcblock. Alternatively, the cross-correlation matrices and auto-correlation matrices may be averaged over a larger surrounding area having similar motion and detail as the mcblock. The interpolation filter may be a rectangular interpolation filter or a circularly-shaped Wiener interpolation filter.

This procedure may produce auto-correlation matrices that are singular, which means that some of the filter coefficients may be chosen arbitrarily. In these cases, the affected coefficients farthest from the center may be chosen to be zero.

The resulting filter may be added to the codebook (box 230). Filters may be added pursuant to vector quantization (“VQ”) clustering techniques, which are designed to either produce a codebook with a desired number of entries or a codebook with a desired accuracy of representation of the filters. Once the codebook is established, it may be transmitted to the decoder (box 240). After transmission, both the encoder and decoder may store a common codebook, which may be referenced during runtime coding operations.

Transmission to a decoder may occur in a variety of ways. The codebook may then be transmitted periodically to the decoder during encoding operations. Alternatively, the codebook may be coded into the decoder a priori, either from coding operations performed on generic training data or by representation in a coding standard. Other embodiments permit a default codebook to be established in an encoder and decoder but to allow the codebook to be updated adaptively by transmissions from the encoder to the decoder.

Indices into the codebook may be variable length coded based on their probability of occurrence, or they may be arithmetically coded.

FIG. 10 illustrates a method for runtime encoding of video, according to an embodiment of the present invention. For each mcblock to be coded, an integer motion vector and reference frame(s) may be computed (box 310), coded and transmitted. Then an N×Wiener interpolation filter may be constructed for the mcblock (box 320) by computing cross-correlation matrices (box 322) and auto-correlation matrices (box 324) averaged over the mcblock. Alternatively, the cross-correlation matrices and auto-correlation matrices may be averaged over a larger surrounding area that has similar motion and detail as the mcblock. The interpolation filter may be a rectangular interpolation filter or a circularly-shaped Wiener interpolation filter.

Once the interpolation filter is established, the codebook may be searched for a previously-stored filter that best matches the newly-constructed interpolation filter (box 330). The matching algorithm may proceed according to vector quantization search methods. When a matching codebook entry is identified, the encoder may code the resulting index and transmit it to a decoder (box 340).

Optionally, in an adaptive process shown in FIG. 10 in phantom, when an encoder identifies a best matching filter from the codebook, it may compare the newly generated interpolation filter with the codebook's filter (box 350). If the differences between the two filters exceed a predetermined error threshold, the encoder may transmit filter characteristics to the decoder, which may cause the decoder to store the characteristics as a new codebook entry (boxes 360-370). If the differences do not exceed the error threshold, the encoder may simply transmit the index of the matching codebook (box 340).

The decoder that receives the integer motion vector, reference frame index and VQ interpolation filter index may use this data to perform motion compensation.

FIG. 11 is a simplified block diagram of a decoder 400 according to an embodiment of the present invention. The decoder 400 may include a block-based decoder 402 that may include a variable length decoder 410, an inverse quantizer 420, an inverse transform unit 430 and an adder 440. The decoder 400 further may include a prediction unit 404 that may include a reference picture cache 450, a motion compensated predictor 460, a codebook 470 and an interpolation filter 480. The prediction unit 404 may generate a predicted pixel block in response to motion compensation data, such as motion vectors and codebook indices received from a channel. The block-based decoder 402 may decode coded pixel block data with reference to the predicted pixel block data to recover pixel data of the pixel blocks.

Specifically, the coded video data may include motion vectors and codebook indices that govern operation of the prediction unit 404. The reference picture cache 450 may store recovered image data of previously decoded frames that were identified as candidates for prediction of later-received coded video data (e.g., decoded I- or P-frames). The motion compensated predictor 460, responsive to mcblock motion vector data, may retrieve a reference mcblock from identified frame(s) stored in the reference picture cache. Typically, a signal reference mcblock is retrieved when decoding a P-coded block and a pair of reference mcblocks are retrieved and averaged together when decoding a B-coded block. The motion compensated predictor 460 may output the resultant mcblock and, optionally, pixels located near to the reference mcblocks, to the interpolation filter 480.

The codebook 470 may supply filter parameter data to the interpolation filter 480 in response to a codebook index received from the channel data associated with the mcblock being decoded. The codebook 470 may be provisioned as storage and control logic to store filter parameter data and output search data in response to a codebook inbox. The interpolation filter 480 may filter the predicted mcblock based on parameter data applied by the codebook 470. The output of the interpolation filter 480 may be input to the block-based coder 402.

With respect to the block-based decoder 402, the coded video data may include coded residual coefficients that have been entropy coded. A variable length decoder 410 may decode data received from a channel buffer according to an entropy coding process to recover quantized coefficients therefrom. The inverse quantizer 420 may multiply coefficient data received from the inverse variable length decoder 410 by a quantization parameter received in the channel data. The inverse quantizer 420 may output recovered coefficient data to the inverse transform unit 430. The inverse transform unit 430 may transform dequantized coefficient data received from the inverse quantizer 420 to pixel data. The inverse transform unit 430, as its name implies, performs the converse of transform operations performed by the transform unit of an encoder (e.g., DCT or wavelet transforms). An adder 440 may add, on a pixel-by-pixel basis, pixel residual data obtained by the inverse transform unit 430 with predicted pixel data obtained from the prediction unit 404. The adder 440 may output recovered mcblock data, from which a recovered frame may be constructed and rendered at a display device (not shown).

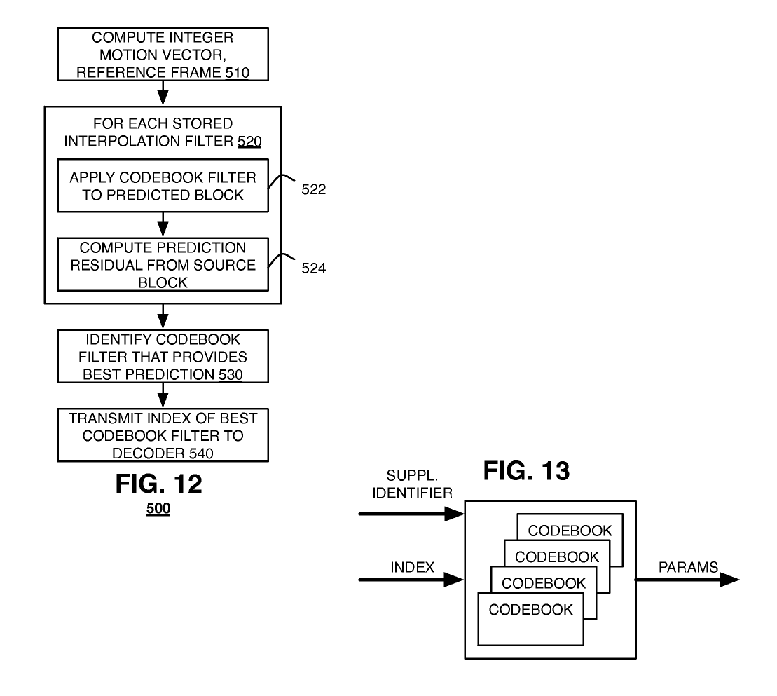

FIG. 12 illustrates a method according to another embodiment of the present invention. For each mcblock, an integer motion vector and reference frame may be computed according to traditional techniques (box 510). Then, an N×N Wiener interpolation filter may be selected by serially determining prediction results that would be obtained by each filter stored in the codebook (box 220). Specifically, for each mcblock, the method may perform filtering operations on a predicted block using either all or a subset of the filters in succession (box 522) and estimate a prediction residual obtained from each codebook filter (box 524). The method may determine which filter configuration gives the best prediction (box 530). The index of that filter may be coded and transmitted to a decoder (box 540). This embodiment, conserves processing resources that otherwise might be spent computing Wiener filters for each source mcblock.

Simplifying Calculation of Wiener Filters

In another embodiment, select filter coefficients may be forced to be equal to other filter coefficients. This embodiment can simplify the calculation of Wiener filters.

Derivation of a Wiener filter for a mcblock involves derivation of an ideal N×1 filter F according to:

F=S⁻¹R

that minimizes the mean squared prediction error. For each pixel p in the mcblock, the matrix F yields a predicted pixel \hat{p} by \hat{p}=F^{T}·Qₚ and a prediction error represented by err=p−\hat{p}.

More specifically, for each pixel p, the vector Qₚ may take the form:

$${Q}_{p} = [ \begin{matrix}{q}_{1} \\ {q}_{2} \\ ⋮ \\ {q}_{N}\end{matrix} ] ,$$

where q₁ to q_{N} represent pixels in or near the translated reference mcblock to be used in the prediction of p.

In the foregoing, R is an N×1 cross-correlation matrix derived from uncoded pixels (p) to be coded and their corresponding Qₚ vectors. In the R matrix, ri at each location i may be derived as p·qi averaged over the pixels p in the mcblock. S is an N×N auto-correlation matrix derived from the N×1 vectors Qₚ. In the S matrix, si,j at each location i,j may be derived as qi·qj averaged over the pixels p in the mcblock. Alternatively, the cross-correlation matrices and auto-correlation matrices may be averaged over a larger surrounding area having similar motion and detail as the mcblock.

Derivation of the S and R matrices occurs for each mcblock being coded. Accordingly, derivation of the Wiener filters involves substantial computational resources at an encoder. According to this embodiment, select filter coefficients in the F matrix may be forced to be equal to each other, which reduces the size of F and, as a consequence, reduces the computational burden at the encoder. Consider an example where filter coefficients f₁ and f₂ are set to be equal each other. In this embodiment, the F and Qₚ matrices may be modified as:

$$F = [ \begin{matrix}{f}_{1} \\ {f}_{3} \\ ⋮ \\ {f}_{N}\end{matrix} ] and {Q}_{p} = [ \begin{matrix}{q}_{1} + {q}_{2} \\ {q}_{3} \\ ⋮ \\ {q}_{N}\end{matrix} ] .$$

Deletion of the single coefficient reduces the size of F and Qₚ both to N−1×1. Deletion of other filter coefficients in F and consolidation of values in Qₚ can result in further reductions to the sizes of the F and Qₚ vectors. For example, it often is advantageous to delete filter coefficients at all positions (save one) that are equidistant to each other from the pixel p. In this manner, derivation of the F matrix is simplified.

In another embodiment, encoders and decoders may store separate codebooks that are indexed not only by the filter index but also by supplemental identifiers (FIG. 13). In such embodiments, the supplemental identifiers may select one of the codebooks as being active and the index may select an entry from within the codebook to be output to the interpolation filter.

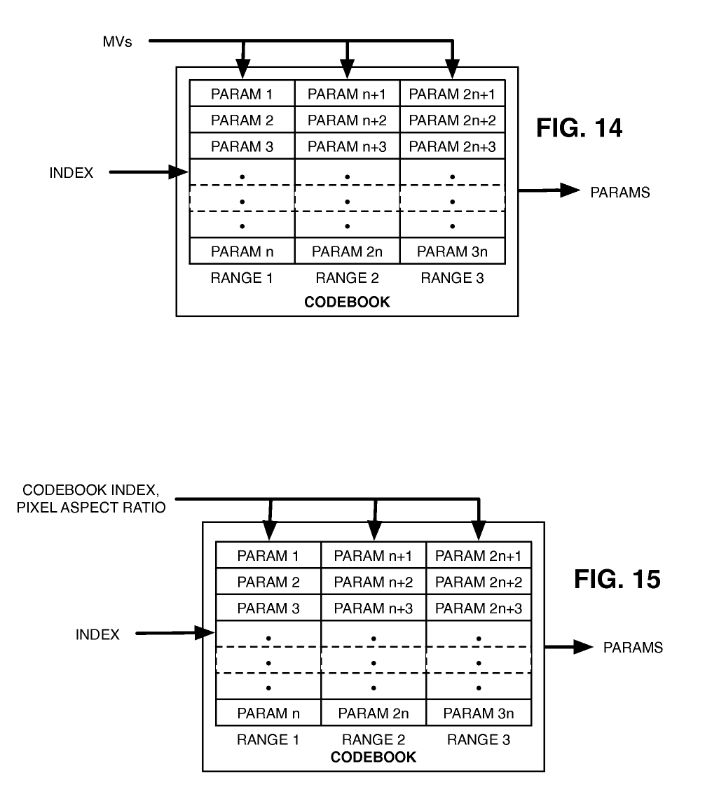

The supplemental identifier may be derived from many sources. In one embodiment, a block's motion vector may serve as the supplemental identifier. Thus, separate codebooks may be provided for each motion vector value or for different ranges of integer motion vectors (FIG. 14). Then in operation, given the value of integer motion vector and reference frame index, the encoder and decoder both may use the corresponding codebook to recover the filter to be used in motion compensation.

In another embodiment, separate codebooks may be provided for different values or ranges of values of deblocking filters present in the current or reference frame. Then in operation, given the values of the deblocking filters, the encoder and decoder use the corresponding codebook to recover the filter to be used in motion compensation.

In a further embodiment, shown in FIG. 15, separate codebooks may be provided for different values or ranges of values of other codec parameters such as pixel aspect ratio and bit rate. Then in operation, given the values of these other codec parameters, the encoder and decoder use the corresponding codebook to recover the filter to be used in motion compensation.

In another embodiment, separate codebooks may be provided for P-frames and B-frames or, alternatively, for coding types (P- or B-coding) applied to each mcblock.

In a further embodiment, different codebooks may be generated from discrete sets of training sequences. The training sequences may be selected to have consistent video characteristics within the feature set, such as speeds of motion, complexity of detail and/or other parameters. Then separate codebooks may be constructed for each value or range of values of the feature set. Features in the feature set, or an approximation thereto, may be either coded and transmitted or, alternatively, derived from coded video data as it is received at the decoder. Thus, the encoder and decoder will store common sets of codebooks, each tailored to characteristics of the training sequences from which they were derived. In operation, for each mcblock, the characteristics of input video data may be measured and compared to the characteristics that were stored from the training sequences. The encoder and decoder may select a codebook that corresponds to the measured characteristics of the input video data to recover the filter to be used in motion compensation.

In yet another embodiment, an encoder may construct separate codebooks arbitrarily and switch among the codebooks by including an express codebook specifier in the channel data.

Toggling Between Fractional Motion Vectors and Integer Motion Vectors

Use of vector coded codebooks to select interpolation filters advantageously allows a video coder to select motion vectors that are integers and to avoid the additional data that would be required to code motion vectors as fractions (e.g., half or quarter pixel distances). In an embodiment, an encoder may toggle between two modes of operation: a first mode in which motion vectors may be coded as fractional values and a default interpolation filter is used for predicted mcblocks and a second mode in which motion vectors are coded as integer distances and the vector coded interpolation filters of the foregoing embodiments are used. Such a system allows an encoder to manage computational resources needed to perform video coding and accuracy of prediction.

In such an embodiment, when fractional motion vectors are communicated from an encoder to a decoder, both units may build a new interpolation filter from the fractional motion vectors and characteristics of the default interpolation filter and store it in the codebook. In this manner, if an encoder determines that more accurate interpolation is achieved via the increased bit rate of fractional motion vectors, the resultant interpolation filter may be stored in the codebook for future use if the interpolation were needed again.

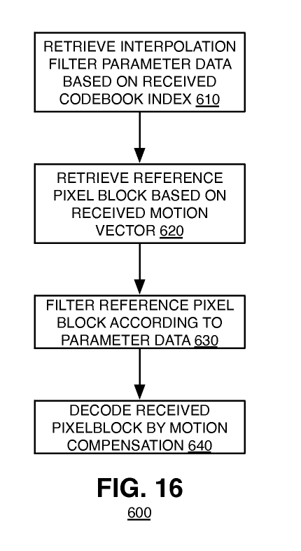

FIG. 16 illustrates a decoding method 600 according to an embodiment of the present invention. The method 600 may be repeated for each coded mcblock received by a decoder from a channel for which integer motion vectors are provided. According to the method, a decoder may retrieve parameters of an interpolation from a local codebook based on an index received in the channel data for the coded mcblock (box 610). The decoder further may retrieve data of a reference mcblock based on a motion vector received from the channel for the coded mcblock (box 620). As noted, depending on the interpolation filter specified by the codebook index, the decoder may retrieve data in excess of a mcblock; for example, the decoder may retrieve pixels adjacent to the mcblock's boundary based on the size of the filter. The method may apply the interpolation filter to the retrieved reference mcblock data (box 630) and decode the coded mcblock by motion compensation using the filtered reference mcblock as a prediction reference (box 640).

Minimizing Mean Square Error Between Filtered Current Mcblocks and their Corresponding Reference Mcblocks

Normally, interpolation filters are designed by minimizing the mean square error between the current mcblocks and their corresponding reference mcblocks over each frame or part of a frame. In an embodiment, the interpolation filters may be designed to minimize the mean square error between filtered current mcblocks and their corresponding reference mcblocks over each frame or part of a frame. The filters used to filter the current mcblocks need not be standardized or known to the decoder. They may adapt to parameters such as those mentioned above, or to others unknown to the decoder such as level of noise in the incoming video.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 8 illustrates the components of the block-based coding chain 110 and prediction unit 120 as separate units, in one or more embodiments, some or all of them may be integrated and they need not be separate units. Such implementation details are immaterial to the operation of the present invention unless otherwise noted above.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A video encoder, comprising:
a block-based coder to code pixel blocks by motion compensated prediction,
a prediction unit to supply predicted pixel block data to the block-based coder, the prediction unit, comprising:
a motion compensated predictor having an output for pixel block data,
an interpolation filter coupled to an output of the motion compensated predictor and having an output for filtered pixel block data, and
codebook storage, storing plural sets of configuration parameters for the interpolation filter, each set of configuration parameters identifiable by a codebook index.

2. The video encoder of claim 1, wherein the codebook is a multi-dimensional codebook, indexed also by a codebook identifier.

3. The video encoder of claim 1, wherein the codebook is a multi-dimensional codebook, indexed also by a motion vector calculated for an input pixel block.

4. The video encoder of claim 1, wherein the codebook is a multi-dimensional codebook, indexed also by an aspect ratio calculated for an input pixel block.

5. The video encoder of claim 1, wherein the codebook is a multi-dimensional codebook, indexed also by coding type assigned to an input pixel block.

6. The video encoder of claim 1, wherein the codebook is a multi-dimensional codebook, indexed also by an indicator of an input pixel block's complexity.

7. The video encoder of claim 1, wherein the codebook is a multi-dimensional codebook, indexed also by an encoder bit rate.

8. The video encoder of claim 1, wherein the codebook is a multi-dimensional codebook, each dimension generated from a respective set of training sequences.

9. A video coding method, comprising:
coding an input pixel block data according to motion compensated prediction, the coding including:
identifying a pixel block from a reference frame as a prediction reference,
calculating characteristics of an ideal filter to be applied to the reference pixel block to match the input pixel block,
searching a codebook of previously-stored filter characteristics to identify a matching codebook filter,
if a match is found, coding the input pixel block with respect to the reference pixel block having been filtered by the matching codebook filter, and
transmitting coded data of the input pixel block and an identifier of the matching codebook filter to a decoder.

10. The video coding method of claim 9, further comprising, if a match is not found:
coding the input pixel block with respect to the reference pixel block having been filtered by the calculated codebook filter, and
transmitting coded data of the input pixel block and data identifying characteristics of the calculated codebook filter to a decoder.

11. The video coding method of claim 9, further comprising, if a match is not found:
coding the input pixel block with respect to the reference pixel block having been filtered by a nearest-matching codebook filter, and
transmitting coded data of the input pixel block and an identifier of the nearest-matching codebook filter to a decoder.

12. The video coding method of claim 9, wherein the codebook is a multi-dimensional codebook, indexed also by a codebook identifier.

13. The video coding method of claim 9, wherein the codebook is a multi-dimensional codebook, indexed also by a motion vector calculated for the input block.

14. The video coding method of claim 9, wherein the codebook is a multi-dimensional codebook, indexed also by an aspect ratio calculated for the input block.

15. The video coding method of claim 9, wherein the codebook is a multi-dimensional codebook, indexed also by coding type assigned to the input block.

16. The video coding method of claim 9, wherein the codebook is a multi-dimensional codebook, indexed also by an indicator of the input block's complexity.

17. The video coding method of claim 9, wherein the codebook is a multi-dimensional codebook, indexed also by an encoder bit rate.

18. The video coding method of claim 9, wherein the codebook is a multi-dimensional codebook, each dimension generated from a respective set of training sequences.

19. The video coding method of claim 9, wherein the coded data of the input pixel block includes motion vectors having integer values.

20. The video coding method of claim 19, further comprising:
coding a second input pixel block data according to motion compensated prediction and a default interpolation filter, and
transmitting coded data of the second input pixel block to a decoder, including motion vectors having fractional values.

21. A video coder control method, comprising:
coding an input pixel block data according to motion compensated prediction, the coding including:
identifying a pixel block from a reference frame as a prediction reference,
calculating characteristics of an ideal filter to be applied to the reference pixel block to match the input pixel block,
searching a codebook of previously-stored filter characteristics to identify a matching codebook filter,
if no match is found, adding the characteristics of the ideal filter to the codebook.

22. The method of claim 21, further comprising:
repeating the method over a predetermined set of training data,
after the training data has been processed, transmitting the codebook to a decoder.

23. The method of claim 21, further comprising:
repeating the method over a sequence of video data, and
each time a new filter is added to the codebook, transmitting characteristics of the filter to a decoder.

24. The method of claim 21, further comprising:
if a match is found, coding the input pixel block with respect to the reference pixel block having been filtered by the matching codebook filter, and
transmitting coded data of the input pixel block and an identifier of the matching codebook filter to a decoder.

25. The method of claim 21, wherein the codebook is a multi-dimensional codebook, the method further comprising:
repeating the method over plural sets of training data, each set of training data having similar motion characteristics, and
building respective dimensions of the codebook therefrom.

26. The method of claim 21, wherein the codebook is a multi-dimensional codebook, the method further comprising:
repeating the method over plural sets of training data, each set of training data having similar image complexity, and
building respective dimensions of the codebook therefrom.

27. The method of claim 21, wherein the codebook is a multi-dimensional codebook, indexed also by a codebook identifier.

28. A video coding method, comprising:
coding an input pixel block data according to motion compensated prediction, the coding including:
identifying a pixel block from a reference frame as a prediction reference;
iteratively:
filtering the reference pixel block by each of a plurality of candidate filter configurations stored in a codebook, and
comparing the input pixel block to the filtered reference pixel block; and
selecting a final filtering configuration from the candidate configurations based on the comparisons; and
transmitting coded data of the input pixel block and a codebook identifier corresponding to the final filtering configuration.

29. A video decoder, comprising:
a block-based coder to decode coded pixel blocks by motion compensated prediction,
a prediction unit to supply predicted pixel block data to the block-based decoder, the prediction unit, comprising:
a motion compensated predictor having an output for pixel block data,
an interpolation filter coupled to an output of the motion compensated predictor and having an output for filtered pixel block data, and
codebook storage, storing plural sets of configuration parameters for the interpolation filter, responsive to a codebook index received with coded pixel block data to supply a set of configuration parameters to the interpolation filter.

30. The video decoder of claim 29, wherein the codebook is a multi-dimensional codebook, indexed also by a codebook identifier.

31. The video decoder of claim 29, wherein the codebook is a multi-dimensional codebook, indexed also by a motion vector of the coded pixel block.

32. The video decoder of claim 29, wherein the codebook is a multi-dimensional codebook, indexed also by a pixel aspect ratio.

33. The video decoder of claim 29, wherein the codebook is a multi-dimensional codebook, indexed also by coding type of the coded pixel block.

34. The video decoder of claim 29, wherein the codebook is a multi-dimensional codebook, indexed also by an indicator of the coded pixel block's complexity.

35. The video decoder of claim 29, wherein the codebook is a multi-dimensional codebook, indexed also by a bit rate of coded video data.

36. A video decoding method, comprising:
decoding coded pixel block data according to motion compensated prediction, the coding including:
retrieving predicted pixel block data from a reference store according to a motion vector,
retrieving filter parameter data from a codebook store according to a codebook index,
filtering the predicted pixel block data according to the parameter data,
wherein the coded pixel block decoding is performed using the filtered pixel block data as a prediction reference.

37. The method of claim 36, wherein the codebook is a multi-dimensional codebook, indexed also by a codebook identifier.

38. The method of claim 36, wherein the codebook is a multi-dimensional codebook, indexed also by a motion vector of the coded pixel block.

39. The method of claim 36, wherein the codebook is a multi-dimensional codebook, indexed also by a pixel aspect ratio.

40. The method of claim 36, wherein the codebook is a multi-dimensional codebook, indexed also by coding type of the coded pixel block.

41. The method of claim 36, wherein the codebook is a multi-dimensional codebook, indexed also by an indicator of the coded pixel block's complexity.

42. The method of claim 36, wherein the codebook is a multi-dimensional codebook, indexed also by a bit rate of coded video data.

43. Computer readable media having program instructions stored thereon that, when executed by a processing device, cause the device to:
code an input pixel block data according to motion compensated prediction, the coding including:
identify a pixel block from a reference frame as a prediction reference,
calculate characteristics of an ideal filter to be applied to the reference pixel block to match the input pixel block,
search a codebook of previously-stored filter characteristics to identify a matching codebook filter,
if a match is found, code the input pixel block with respect to the reference pixel block having been filtered by the matching codebook filter, and
transmit coded data of the input pixel block and an identifier of the matching codebook filter to a decoder.

44. A coded video signal, carried on a physical transmission medium, generated according to the process of:
coding an input pixel block data according to motion compensated prediction, the coding including:
identifying a pixel block from a reference frame as a prediction reference,
calculating characteristics of an ideal filter to be applied to the reference pixel block to match the input pixel block,
searching a codebook of previously-stored filter characteristics to identify a matching codebook filter, and
if a match is found, coding the input pixel block with respect to the reference pixel block having been filtered by the matching codebook filter; and
transmitting coded data of the input pixel block and an identifier of the matching codebook filter to a decoder.

45. The coded video signal of claim 44, wherein the coded video signal includes integer-valued motion vectors for the coded pixel block.

46. The coded video signal of claim 44, wherein the coded video signal includes data of a second coded pixel block, coded according to motion compensated prediction performed with respect to a default interpolation filter, the second pixel block data including coded data and a fractional valued motion vectors therefor.

47. Computer readable media having program instructions stored thereon that, when executed by a processing device, cause the device to:
decode coded pixel block data according to motion compensated prediction, the coding including:
retrieve predicted pixel block data from a reference store according to a motion vector,
retrieve filter parameter data from a codebook store according to a codebook index,
filter the predicted pixel block data according to the parameter data,
wherein the coded pixel block decoding is performed using the filtered pixel block data as a prediction reference.
